(19) United States
(12) Patent Application Publication
(10) Pub. No.: US 2017/0301128 A1
(43) Pub. Date: Oct. 19, 2017

(54) SYSTEM FOR SYNCHRONIZING 3D IMAGE MULTIPLE SCREENS IN REAL-TIME

(71) Applicant: THE MACKISS COMPANY INC., Daejeon (KR)

(72) Inventors: Woong-Rae CHO, Daejeon (KR); Keun-Soo KIM, Seoul (KR); Su-Jin KIM, Seoul (KR)

(73) Assignee: THE MACKISS COMPANY INC., Daejeon (KR)

(21) Appl. No.: 15/516,612

(22) PCT Filed: Sep. 16, 2015
(86) PCT No.: PCT/KR2015/009691

§ 371 Date: Apr. 3, 2017

(30) Foreign Application Priority Data
Oct. 8, 2014 (KR) 10-2014-0136080

(51) Int. Cl. G06T 15/00; H04N 21/242; H04N 13/04

(52) U.S. Cl. CPC G06T 15/005; H04N 13/04; H04N 21/242

(57) ABSTRACT

Disclosed is a system for synchronizing 3D image multiple screens in real-time. The system comprises: an operation server for playing back 3D content; a plurality of displays displaying the whole, each display displaying just a part of the 3D content; a plurality of rendering clients each rendering just a part of the 3D content to output to a corresponding display; and a synchronization integration control server for controlling so that the plurality of rendering clients can render while synchronized.

### TECHNICAL FIELD

The present invention relates to a technique for implementing a three-dimensional (3D) image screen, and more particularly, to a technique for implementing one very large 3D image screen through a plurality of displays.

### BACKGROUND ART

Multi-display systems are well known. The multi-display system is a system that divides one image over a plurality of displays and displays the image. In Korean Patent Application Laid-Open No. 10-2010-0003652, such a multi-display system is disclosed.

### DISCLOSURE

### Technical Problem

The present invention is directed to providing a system for implementing one very large image screen which displays a three-dimensional (3D) image in real-time using a plurality of rendering clients.

### Technical Solution

One aspect of the present invention provides a real-time three-dimensional (3D) image multi-screen synchronization system including an operation server configured to play back 3D content, a plurality of displays configured to display the whole of the 3D content, wherein each of the displays displays only a part of the 3D content, a plurality of rendering clients, wherein each of the rendering clients renders only a part of the 3D content and outputs the part of the 3D content to a corresponding display, and a synchronization integration control server configured to control the plurality of rendering clients to be synchronized and render the part of the 3D content.

The real-time 3D image multi-screen synchronization system may further include an image processing server connected to the plurality of rendering clients and configured to process a rendering result according to a curvature or 3D shape of a screen.

The real-time 3D image multi-screen synchronization system may further include a plurality of sensor clients connected to the operation server, configured to sense a viewer and allow the 3D content to react to the viewer.

The plurality of rendering clients may receive only a 3D object which moves on a fixed background image displayed on the displays from the operation server, render the 3D object, and then output the rendered 3D object to overlap the background image.

### Advantageous Effects

In the disclosed system, a very large image screen which displays a three-dimensional (3D) image in real-time using a plurality of rendering clients is implemented. The disclosed system can perform fast screen processing through split rendering for the entire screen, and can also be effective even when changing only a part of the entire screen. Further, the disclosed system can ensure that the entire image is displayed at the same timing through synchronization integration control even when an image is output through split rendering.

### DESCRIPTION OF DRAWINGS

FIG. 1 is a block diagram of a real-time three-dimensional (3D) image multi-screen synchronization system according to one embodiment of the present invention.

### MODES OF THE INVENTION

The above-described aspects and additional aspects of the present invention will become clear from exemplary embodiments that will be described with reference to the accompanying drawings. Hereinafter, in order to facilitate understanding and reproduction by those skilled in the art, the present invention will be described in detail by explaining exemplary embodiments.

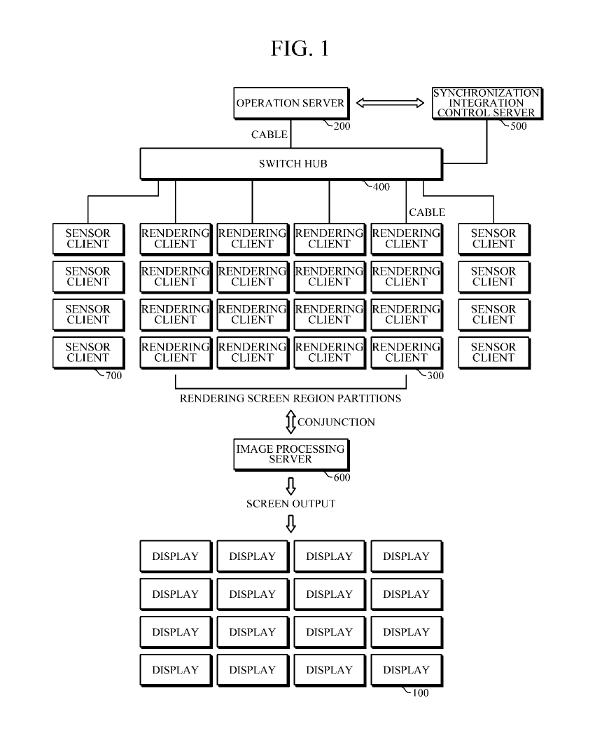

FIG. 1 is a block diagram of a real-time three-dimensional (3D) image multi-screen synchronization system according to one embodiment of the present invention. Components included in the real-time 3D image multi-screen synchronization system are connected to each other via a network. Displays 100 constitute one large display. That is, the displays 100 are arranged in various ways to form a large screen which displays one piece of 3D content. Twenty or more displays 100 may be arranged in various forms. Further, the displays 100 may be arranged in various forms as well as being arranged in a planar form. For example, the displays 100 may be arranged at various angles on planes, curved surfaces, slopes, ceilings, or the like to form one large screen. Each of the displays 100 may be a flat display, or may also be a flexible display for various types of arrangements. Such displays 100 are arranged in a very large area so as to allow a viewer to go around the area and see the area. That is, the system illustrated in FIG. 1 may be a system for implementing a type of theme park.

An operation server 200 plays back 3D content and allows the played back content to be displayed on the distant displays 100. Each of the displays 100 displays only a predetermined part of the entire 3D content, and thus one large 3D content screen is generated. The 3D content may be game content and content which interacts with a viewer. Such 3D content may include multimedia data in which a large number of characters appear over a very large area such as the Battle of Three Kingdoms.

A plurality of rendering clients 300 may be controlled by the operation server 200 and may be in one-to-one correspondence with the displays 100. Each of the rendering clients 300 receives only some data of the 3D content, that is, a part to be displayed on the corresponding display 100, from the operation server 200 through a switch hub 400, renders the received data, and outputs the rendered data to the corresponding display 100. That is, an area in charge is assigned to each of the rendering clients 300 in order to generate one large image, and each of the rendering clients 300 serves to render an image in real-time.

A synchronization integration control server 500 is connected to the rendering clients 300 and controls each of the rendering clients 300 to be synchronized when rendering and render some data 300. By the synchronization control of the synchronization integration control server 500, the rendering clients 300 are synchronized with each other, render some data, and output the rendered data to the corresponding displays 100. Accordingly, multiple screens output images at the same timing. In one embodiment, the synchronization integration control server 500 may be a server configured as a single unit with the operation server 200. That is, a synchronization control function may be included in the operation server 200.

According to another aspect, the real-time 3D image multi-screen synchronization system may further include an image processing server 600. The image processing server 600 is connected to the rendering clients 300. The image processing server 600 processes rendering results of the rendering clients 300 in accordance with a screen curvature or a 3D shape of the corresponding displays 100 in conjunction with the rendering clients 300. In a flexible display, an image should be displayed in accordance with a screen curvature or a 3D shape due to a bending property instead of a simple plane. Therefore, the rendering clients 300 display a synchronized image in conjunction with the image processing server 600.

According to still another aspect, the real-time 3D image multi-screen synchronization system further includes a plurality of sensor clients 700. The sensor clients 700 may be connected to the operation server 200, and may be connected through the switch hub as illustrated in FIG. 1. The sensor client 700 is configured to allow 3D content to react to a viewer, and is a device that may sense a presence of the viewer and further sense a gesture of the viewer. In order to sense a gesture of a user, each of the sensor clients 700 may include a gyro sensor, a camera, or the like. A sensing event of the sensor clients 700 is transferred to the operation server 200, and the operation server 200 causes the 3D content to react according to the sensing event. In other words, the operation server 200 performs an event command to interactively change the 3D content, for example, snow falling, crows flying, or night and day switching. The operation server 200 transfers only 3D data of an area which needs to be changed in the entire screen to the corresponding rendering client 300, and the rendering client 300 receives and renders the 3D data and outputs the rendered 3D data to the corresponding display 100.

Meanwhile, the 3D content may include a background image and 3D characters (3D objects) which move on the background image. Here, the background image may be fixed. In this case, the rendering clients 300 may receive only 3D data corresponding to the 3D characters which moves on the fixed background image from the operation server 200, render the 3D data, and then display the rendered 3D data to overlap the original background image. Further, the rendering clients 300 may receive only 3D data which should be changed even when the sensing event of the sensor clients 700 is generated from the operation server 200, render the 3D data, and then display the rendered 3D data to overlap the original background image.

While the present invention has been particularly described with reference to exemplary embodiments, it should be understood by those skilled in the art that various changes in form and details may be made without departing from the spirit and scope of the present invention. Therefore, the exemplary embodiments should be considered in a descriptive sense only and not for purposes of limitation. The scope of the invention is defined not by the detailed description of the invention but by the appended claims, and encompasses all modifications and equivalents that fall within the scope of the appended claims and are construed as being included in the present invention.

1. A real-time three-dimensional (3D) image multi-screen synchronization system comprising:
an operation server configured to play back 3D content;
a plurality of displays configured to display the whole of the 3D content, wherein each of the displays displays only a part of the 3D content;
a plurality of rendering clients, wherein each of the rendering clients renders only a part of the 3D content and outputs the part of the 3D content to a corresponding display; and
a synchronization integration control server configured to control the plurality of rendering clients to be synchronized and render the part of the 3D content.

2. The real-time 3D image multi-screen synchronization system of claim 1, further comprising an image processing server connected to the plurality of rendering clients and configured to process a rendering result according to a curvature or 3D shape of a screen.

3. The real-time 3D image multi-screen synchronization system of claim 1, further comprising a plurality of sensor clients connected to the operation server, configured to sense a viewer and allow the 3D content to react to the viewer.

4. The real-time 3D image multi-screen synchronization system of claim 1, wherein the plurality of rendering clients receive only a 3D object which moves on a fixed background image displayed on the displays from the operation server, render the 3D object, and then output the rendered 3D object to overlap the background image.
